(19) United States
(12) Patent Application Publication
(10) Pub. No.: US 2025/0007416 A1
(43) Pub. Date: Jan. 2, 2025

(54) METHOD FOR GENERATING OUTPUT VOLTAGE USING HSC CONVERTER

(71) Applicant: Murata Manufacturing Co., Ltd., Nagaokakyo-shi (JP)

(72) Inventors: Shohei MASUDA, San Jose, CA (US); Hajime SHIJI, San Jose, CA (US)

(21) Appl. No.: 18/756,393

(22) Filed: Jun. 27, 2024

Related U.S. Application Data
(60) Provisional application No. 63/524,316, filed on Jun. 30, 2023.

(51) Int. Cl. H02M 3/335; H01F 27/29; H02M 3/00

(52) U.S. Cl. CPC H02M 3/33584; H01F 27/29; H02M 3/01; H02M 3/33571; H02M 3/33573

(57) ABSTRACT

An HSC voltage conversion module includes an input voltage, a transformer without a primary winding and including secondary windings magnetically coupled by a magnetic core, first and second switch bridges connected to the transformer and to the input voltage, and an output capacitor that is connected to a single node of the transformer and that provides an output voltage that is one quarter of the input voltage.

### CROSS REFERENCE TO RELATED APPLICATIONS

This application claims the benefit of U.S. Patent Application No. 63/524,316 filed on Jun. 30, 2023. The entire contents of this application are hereby incorporated by reference.

### BACKGROUND OF THE INVENTION

### 1. Field of the Invention

The present invention relates to DC-DC converters. More specifically, the present invention relates to hybrid switched-capacitor (HSC) converters that provide an output voltage that is one quarter of an input voltage.

### 2. Description of the Related Art

It is known to use two-stage conversion in which the first stage is an LLC resonant converter and the second stage is a point-of-load (POL) converter. The LLC resonant converter is used as an intermediate bus converter with zero-voltage switching (ZVS) on the primary side or the high-voltage (HV) side and with zero-current switching (ZCS) on the secondary side or low-voltage (LV) side. If isolation is not required, the first stage can be an unregulated zero-voltage-switching, switched-capacitor converter.

To reduce the size of the converter's footprint, high switching frequency operation is needed in the first and the second stages. However, high-frequency operation, especially on the first stage (i.e., 1 MHz to 2 MHZ), leads to higher losses (i.e., switching, gate-driving, and conduction losses). A high step-down ratio can be desirable for the first stage in some applications to reduce losses, including, for example, switching and conduction losses. For 48-V power deliver applications, the step-down ratio of the first stage is 8:1 to provide a 6-V intermediate bus. The reduction of the 48-V input voltage to the 6-V intermediate bus voltage enables higher-power density, while maintaining high efficiency. Switched capacitor (SC) converters provide high conversion ratios, but SC converters are complex and bulky in terms of floating driver requirements and the number of required switches and ceramic capacitors. LLC converters with a center-tapped rectifier provide high conversion ratios with less complexity, but, when isolation is not required, non-isolated topologies are preferred because of increased power density. In low-output-voltage applications, LLC converters with a center-tapped rectifier can be used, but this topology has suboptimal copper utilization because the secondary windings are conducting for half of the switching cycle.

It is known to use hybrid switched-capacitor (HSC) converters that overcome the limitations of switched-capacitor converters and LLC converters for high step-down ratios. HSC converters combine the benefits of switched-capacitor converters and the high step-down ratio capability of transformer-based converters. By transferring energy through capacitors and a magnetic device, efficiency and power density can be significantly improved. But known HSC converters cannot provide an output voltage that is one quarter of the input voltage. In applications in which an output voltage that is one quarter of the input voltage, a different topology is required, for example, an LLC topology. In an LLC converter, because the current in the secondary winding is subjected to half-wave rectification, the current peak value is large, resulting in losses.

### SUMMARY OF THE INVENTION

To overcome the problems described above, example embodiments of the present invention provide HSC converters that include a transformer with no primary windings and that provide an output voltage that is one quarter of the input voltage.

According to an example embodiment, an HSC voltage conversion module includes an input voltage, a transformer without a primary winding and including secondary windings magnetically coupled by a magnetic core, first and second switch bridges connected to the transformer and to the input voltage, and an output capacitor that is connected to a single node of the transformer and that provides an output voltage that is one quarter of the input voltage.

The HSC voltage conversion module can further include a first resonant circuit connected between the first switch bridge and the transformer and a second resonant circuit connected between the second switch bridge and the transformer. The first resonant circuit can include a first resonant capacitor, the second resonant circuit can include a second resonant capacitor, and the first and the second resonant circuits can rely on a leakage inductance of the transformer.

Each of the first and second switch bridges can include first, second, and third switches connected in series. Secondary windings of the transformer can include first and second windings. The HSC voltage conversion module can be bidirectional.

According to an example embodiment of the present invention, a converter includes an input terminal that receives an input voltage; a first switch bridge connected in parallel across the input voltage and including first, second, and third switches connected in series, a first node between the first and the second switches, and a third node between the second and third switches; a second switch bridge including fourth, fifth, and sixth switches connected in series, a second node between the fourth and the fifth switches, and a fourth node between the fifth and sixth switches; an output capacitor; a transformer including a single winding that includes first and second secondary windings that are physically connected to each other to define a secondary winding group and that are magnetically coupled by a magnetic core and including a single tap connected to the output capacitor; a first resonant circuit connected between the first node and a first end of the single winding; a second resonant circuit connected between the second node and a second end of the single winding opposite to the first end of the single winding; and an output terminal connected to the first output capacitor to provide a first output voltage that is one quarter of the input voltage.

The first resonant circuit can include a first resonant capacitor, the second resonant circuit can include a second resonant capacitor, and the first and the second resonant circuits can rely on a leakage inductance of the transformer.

The converter is can be bidirectional such that power can flow from the input terminal to the output terminal and from the output terminal to the input terminal.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a hybrid switched-capacitor (HSC) converter of the related art.

FIG. 2 shows an HSC converter with no primary windings and two connected secondary windings.

FIG. 3 shows different current paths of the HSC converter of FIG. 2.

FIGS. 4A and 4B show graphs of different waveforms of the HSC converter of FIG. 2.

FIG. 5 shows a table comparing the properties of an LLC converter and an HSC converter.

FIG. 6 shows graphs of different waveforms of an LLC converter.

FIG. 7 shows graphs of different waveforms of an HSC converter.

FIG. 8 shows a table of the different properties of the LLC converter and HSC converter used in FIGS. 7 and 8.

FIGS. 9A-9C show graphs of the waveforms showing simulation results for an HSC converter of FIG. 2.

### DETAILED DESCRIPTION OF EXAMPLE EMBODIMENTS

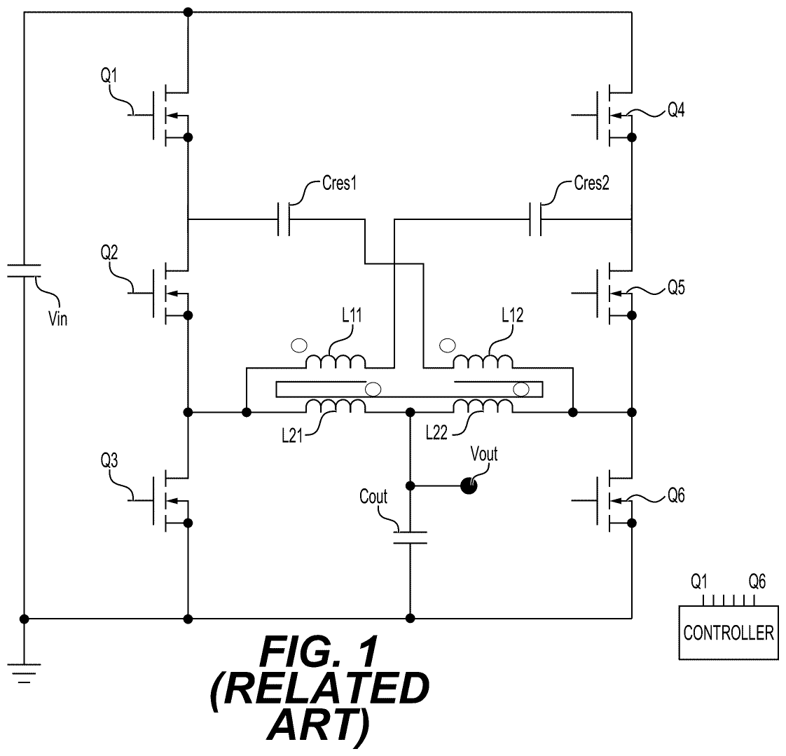

FIG. 1 is a circuit diagram of a hybrid switched-capacitor (HSC) converter of the related art that includes a single output. The HSC converter of FIG. 1 includes an input voltage Vin, first and second bridges, a transformer connected between the first and the second bridges, a first resonant circuit connected between the first bridge and the transformer, a second resonant circuit connected between the second bridge and the transformer, a first output capacitor Cout connected to the transformer, and an output terminal Vout connected to the output capacitor Cout.

The input voltage Vin of the HSC converter of FIG. 1 can be any suitable DC voltage source and can provide any suitable DC voltage, including, for example, 48 V. The output voltage Vout depends on the number of turns in the windings L11-L22, as provided by equation (1) below.

The first and second bridges of the HSC converter of FIG. 1 can be connected in parallel between the input voltage Vin and ground. The first bridge includes switches Q1, Q2, Q3 connected in series with the second switch Q2 connected between the first switch Q1 and the third switch Q3, and the second bridge includes switches Q4, Q5, Q6 connected in series with the fifth switch Q5 connected between the fourth switch Q4 and the sixth switch Q6. A first node can be located between the first switch Q1 and the second switch Q2, a second node can be located between the second switch Q2 and the third switch Q3, a third node can be located between the fourth switch Q4 and the fifth switch Q5, and a fourth node can be located between the fifth switch Q5 and the sixth switch Q6. The switches Q1-Q6 can be divided into a first switch group including switches Q1, Q3, Q5 and a second switch group including Q2, Q4, Q6. The first and second switch groups can be complementarily controlled with a 180° phase-shifted pulse-width modulator (PWM). The first and the second switch groups can be controlled with the same fixed duty cycle that can be close to 50% to reduce or minimize root-mean-square (RMS) current. The switches Q1-Q6 can be controlled by a controller that provides drive signals to the switches Q1-Q6. Any suitable controller can be used and can be implemented in hardware and/or software. The controller can be configured and/or programmed to provide the functions described herein.

The transformer of the HSC converter of FIG. 1 can be a multi-tapped autotransformer that includes a single winding that includes a first winding L12, a second winding L22, a third winding L21, and a fourth winding L11. The first winding L12 is physically connected to the second winding L22, which is physically connected to the third winding L21, which is physically connected to the fourth winding L11. The first end of the single winding of the transformer (i.e., the end of the first winding L12 not connected to the second winding L22) can be connected to the first resonant circuit, and the second end of the single winding of the transformer (i.e., the end of the fourth winding L11 not connected to the third winding L21) can be connected to the second resonant circuit. The first winding L12, the second winding L22, the third winding L21, and the fourth winding L11 can be magnetically coupled with a magnetic core.

The single winding of the transformer of the HSC converter of FIG. 1 can include a first tap between the first winding L12 and the second winding L22, a second tap between the second winding L22 and the third winding L21, and a third tap between the third winding L21 and the fourth winding L11. The first tap can be connected to the fourth node between the fifth switch Q5 and the sixth switch Q6. The second tap can be connected to the output capacitor Cout. The third tap can be connected to the second node between the second switch Q2 and the third switch Q3.

In the HSC converter of FIG. 1, a first winding group or primary winding group of the transformer can include the windings between the first end of transformer and the first tap of the transformer (i.e., the first winding L12) and the windings between the second end of the transformer and the third tap of the transformer (i.e., the fourth winding L11). A second winding group or secondary winding group of the transformer can include the windings between the first and second taps of transformer (i.e., the second winding L22) and the windings between the second and third taps of the transformer (i.e., the third winding L21). Because the windings L11-L22 are physically connected to each other, the primary and the secondary winding groups are not isolated from each other. The HSC converter of FIG. 1 is a non-isolated DC-DC converter.

In the HSC converter of FIG. 1, the first resonant circuit can include a first resonant capacitor Cres1, and the first resonant circuit can be connected between the first winding L12 and the first node between the first switch Q1 and the second switch Q2. In the HSC converter of FIG. 1, the second resonant circuit can include a second resonant capacitor Cres2, and the second resonant circuit can be connected between the fourth winding L11 and the third node between the fourth switch Q4 and the fifth switch Q6. The first and second resonant circuits can use the leakage inductance of the transformer. Alternatively, the first and second resonant circuits can use discrete inductors.

The output terminal Vout of the HSC converter of FIG. 1 provides a single output voltage. The single output voltage can be an unregulated output voltage. The ratio between the input voltage Vin and the output voltage Vout is provided by the following equation:

$$Vout = \frac{V in}{4 + 2 \frac{{N}_{1}}{{N}_{2}}} \qquad ( 1 )$$

where Vout is the output voltage at the output terminal Vout, Vin is the voltage of the input voltage Vin, N1 is the number of turns of the first and the fourth windings L12, L11, and N2 is the number of turns of the second and the third windings L22, L21. The output voltage Vout can be adjusted by adjusting the number of turns in the windings L11-L22. But the output voltage Vout cannot be adjusted to one quarter of the input voltage, no matter how the numbers of turns in the windings L11-L22 are adjusted.

In applications in which an output voltage is one quarter of the input voltage, a different topology is typically required, for example, an LLC topology. In an LLC converter, because the current in the secondary winding is subjected to half-wave rectification, the current peak value is large, resulting in losses.

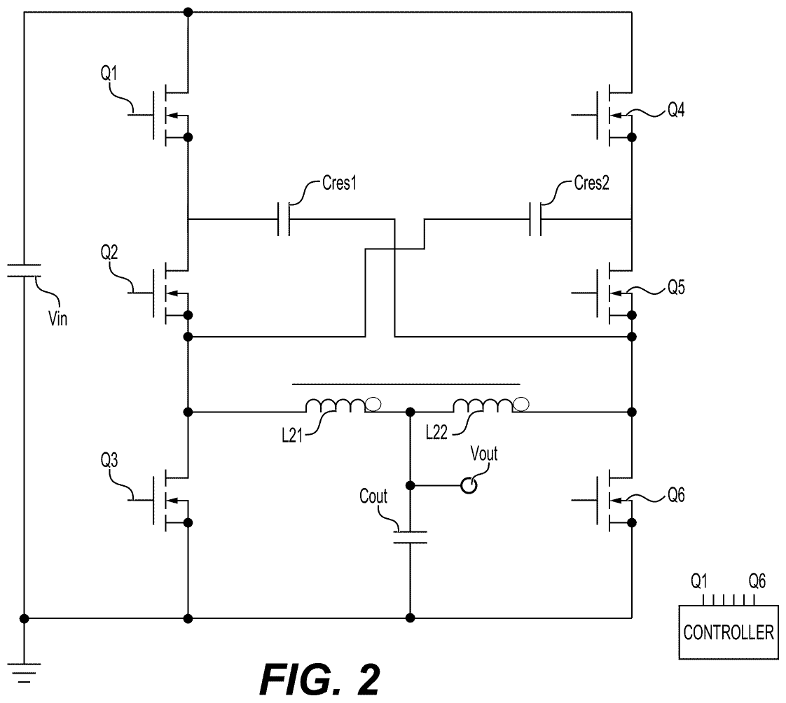

FIG. 2 shows an HSC converter in which the output voltage is one quarter of the input voltage. In the HSC converter of FIG. 2, an autotransformer includes a first winding L22 and a second winding L21 but does not include any primary windings. The autotransformer of FIG. 2 includes a single tap which is connected to the output capacitor Cout. Compared to the HSC converter of FIG. 1, the HSC converter of FIG. 2 does not include the first winding L12 or the fourth winding L11. The transformer in FIG. 2 only includes two windings (i.e., the windings L22, L21). The transformer in FIG. 2 only includes secondary windings and does not include any primary windings. By not including the primary windings, copper loss, which is the loss caused by current flowing through copper foil, generated in the primary winding is eliminated. Because the structure of the transformer is simplified, the space occupied by the primary winding can be more effectively utilized.

As with the HSC converter of FIG. 1, the HSC converter of FIG. 2 includes an input voltage Vin, first and second bridges, a transformer connected between the first and the second bridges, a first resonant circuit connected between the first bridge and the transformer, a second resonant circuit connected between the second bridge and the transformer, a first output capacitor Cout connected to the transformer, and an output terminal Vout connected to the output capacitor Cout.

The first and second bridges of the HSC converter of FIG. 2 can be connected in parallel between the input voltage Vin and ground. The first bridge includes switches Q1, Q2, Q3 connected in series with the second switch Q2 connected between the first switch Q1 and the third switch Q3, and the second bridge includes switches Q4, Q5, Q6 connected in series with the fifth switch Q5 connected between the fourth switch Q4 and the sixth switch Q6. A first node can be located between the first switch Q1 and the second switch Q2, a second node can be located between the second switch Q2 and the third switch Q3, a third node can be located between the fourth switch Q4 and the fifth switch Q5, and a fourth node can be located between the fifth switch Q5 and the sixth switch Q6. The switches Q1-Q6 can be divided into a first switch group including switches Q1, Q3, Q5 and a second switch group including Q2, Q4, Q6. The first and second switch groups can be complementarily controlled with a 180° phase-shifted pulse-width modulator (PWM). The first and the second switch groups can be controlled with the same fixed duty cycle that can be close to 50% to reduce or minimize root-mean-square (RMS) current. The switches Q1-Q6 can be controlled by a controller that provides drive signals to the switches Q1-Q6. Any suitable controller can be used and can be implemented in hardware and/or software. The controller can be configured and/or programmed to provide the functions described herein.

The transformer of the HSC converter of FIG. 2 can be a single-tapped autotransformer that includes a single winding that includes the first winding L22 and the second winding L21. The first winding L22 is physically connected to the second winding L21. The first end of the single winding of the transformer (i.e., the end of the first winding L22 not connected to the second winding L21) can be connected to the first resonant circuit, and the second end of the single winding of the transformer (i.e., the end of the second winding L21 not connected to the first winding L22) can be connected to the second resonant circuit. The first winding L22 and the second winding L21 can be magnetically coupled with a magnetic core.

The single winding of the transformer of the HSC converter of FIG. 2 can include a single tap between the first winding L22 and the second winding L21. The single tap can be connected to the output capacitor Cout.

The transformer of the HSC converter of FIG. 2 includes a single winding group or secondary winding group. The single winding group or secondary winding group of the transformer can include the windings between the first end of transformer and the second end of the transformer (i.e., the first winding L22 and the second winding 21). Because the windings L21 and L22 are physically connected to each other, the HSC converter of FIG. 2 is a non-isolated DC-DC converter.

In the HSC converter of FIG. 2, the first resonant circuit can include a first resonant capacitor Cres1, and the first resonant circuit can be connected between the first winding L12 and the first node between the first switch Q1 and the second switch Q2. In the HSC converter of FIG. 2, the second resonant circuit can include a second resonant capacitor Cres2, and the second resonant circuit can be connected between the fourth winding L11 and the third node between the fourth switch Q4 and the fifth switch Q6. The first and second resonant circuits can use the leakage inductance of the transformer. Alternatively, the first and second resonant circuits can use discrete inductors.

The output terminal Vout of the HSC converter of FIG. 1 provides a single output voltage. The single output voltage can be an unregulated output voltage. The ratio between the input voltage Vin and the output voltage Vout is provided by the following equation:

$${V}_{o u t} = \frac{{V}_{i n}}{4} \qquad ( 2 )$$

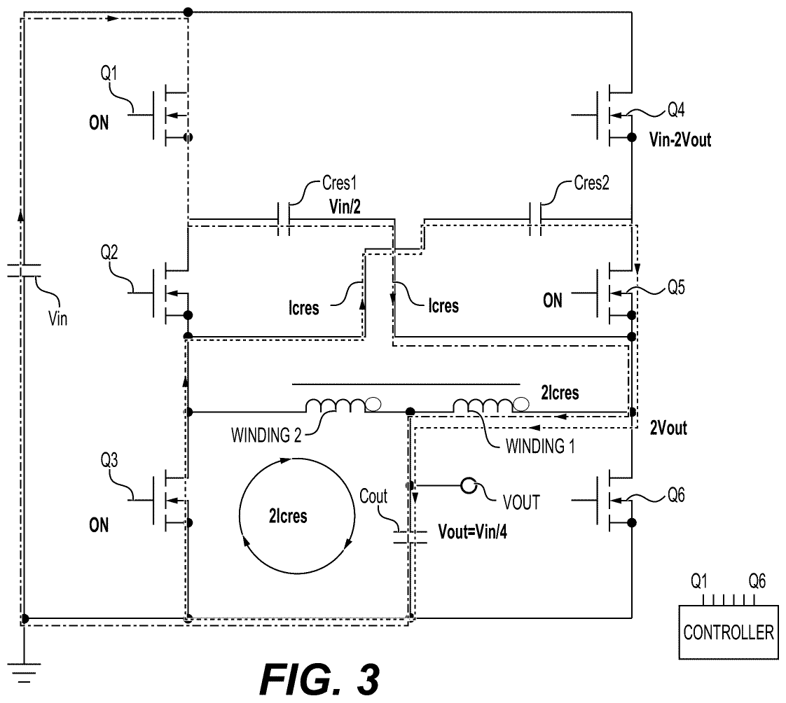

FIG. 3 shows different current paths in the HSC converter of FIG. 2. A first current path is from one terminal of the input voltage Vin, the switch Q1, which is on, and the first node, then through the first resonant circuit and the fourth node, then through the first winding L22 (i.e., winding 1) and the single tap, then the output capacitor Cout, and then to the other terminal of the input voltage Vin connected to ground, creating a first current loop including the input voltage, the first switch Q1, the first resonant circuit, the first winding L22 (i.e., winding 1), and the output capacitor Cout. A second current path is from the second node through the second resonant circuit, and then through the fifth switch, which is on, and the fourth node, then through the first winding L21 (i.e., winding 1) and the single tap, then the output capacitor Cout, and then through the third switch Q3 and back to the second node, creating a second current loop including the second resonant circuit, the fifth switch Q5, the first winding L22 (i.e., winding 1), the output capacitor Cout, and the third switch Q3. The first and the second current paths in the first winding L22 (i.e., winding 1) induce a third current path in the second winding L21 (i.e., winding 2). The third current path is through the second winding L21 (i.e., winding 2) and the single tap, then through the output capacitor Cout, then through the third switch Q3, and back to the second winding L21 (i.e., winding 2), creating a third current loop including the second winding L21 (i.e., winding 2), the output capacitor Cout, and the third switch Q3. The output terminal Vout is connected to the output capacitor Cout and the first, the second, and the third current loops. In FIG. 3, the capacitances of the first resonant capacitor Cres1 and the second resonant capacitor Cres2 are the same so that Cres1=Cres2=Cres. In addition, the first switch group, including switches Q1, Q3, Q5, is turned on, and the second switch group, including switches Q2, Q4, Q6, are turned off. The switches Q1-Q6 can be switched with a frequency provided the following equation:

$${f}_{s w} = \frac{1}{2 π \sqrt{{L}_{k} {C}_{c r e s}}} \qquad ( 3 )$$

where f_{sw} is the switching frequency, Lₖ is the leakage inductance of the windings, and C_{cres} is the capacitance of the resonant capacitors Cres1, Cres2. The voltage of the resonant capacitors Cres1, Cres2 is one half of the input voltage as provided by the following equation:

$${V}_{c r e s} = \frac{{V}_{i n}}{2} \qquad ( 4 )$$

where V_{cres} is the voltage of the resonant capacitors Cres1, Cres2, and Vin is the voltage of the input voltage. The currents in the first and the second resonant circuits are equal and are provided by the following equation:

$${I}_{cres 1} = {I}_{c res 2} = {I}_{c r e s} = \frac{{I}_{out DC} * π}{8} \qquad ( 5 )$$

where I_{cres1}, I_{cres2} are the currents in the first and the second resonant circuits, I_{cres} is the current through either the first or the second resonant circuit, and I_{outDC} is the output current. The root-mean-square (RMS) current through the switch Q1 is one half the current through the first resonant circuit as provided by the following equation:

$${I}_{Q 1 ( r m s )} = \frac{{I}_{c r e s}}{2} = \frac{{I}_{out DC} * π}{2 * 8} = \frac{{I}_{out DC} * π}{16} \qquad ( 6 )$$

where I_{Q1(rms)} is the RMS current through the first switch Q1. The RMC current through the third switch Q3 is three halves of the current through the second resonant circuit as provided by the following equation:

$${I}_{Q 3 ( rms )} = \frac{3 {I}_{c r e s}}{2} = \frac{3 {I}_{out DC} * π}{2 * 8} = \frac{3}{16} {I}_{out DC} * π \qquad ( 7 )$$

where I_{Q3(rms)} is the RMS current through the first switch Q3. The current through the first winding L22 (labeled as winding 1 in FIG. 3) and the second winding L21 (labeled as winding 2 in FIG. 3) is the current through both the first and the second resonant circuits as provided by the following equation:

$${I}_{winding 1} = {I}_{winding 2} = 2 * {I}_{c r e s} = \frac{{I}_{out DC} * π}{4} \qquad ( 8 )$$

where I_{winding1} is the current through the first winding L22 and I_{winding2} is the current through the second winding L21.

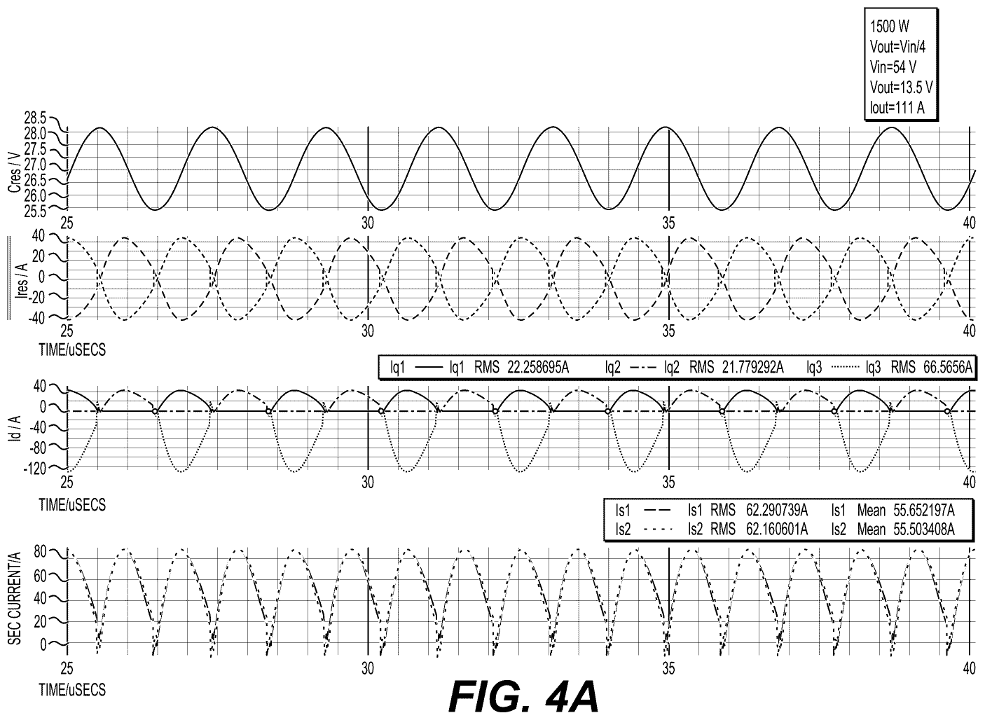

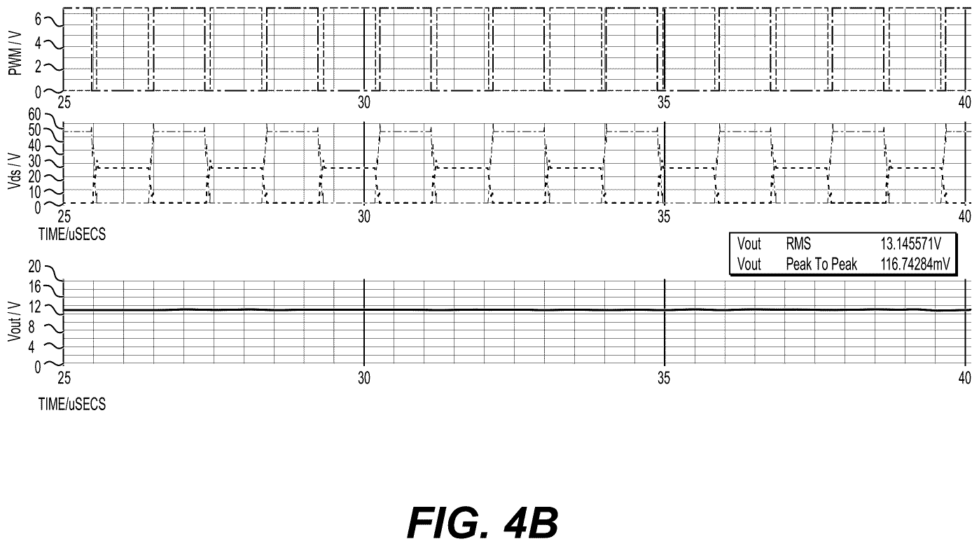

FIGS. 4A and 4B show waveforms of a simulation of a 1500-W HSC converter of FIG. 2 that includes a 54-V input, 13.5-V output (=Vin/4=54 V/4), and 111-A output current. The switches in the first and second bridges can be driven with two PWM signals with an arbitrary frequency but with a 180° phase difference. Accordingly, a resonant current Ires can be generated in the first and the second resonant circuits, which each include a resonant capacitor and a resonant inductor, which is either a leakage inductance of the transformer or a discrete inductor. The resonant current Ires flows through each of the switches Q1 and Q2. Twice the resonant current Ires is induced in the second winding L21 of the transformer, and triple the resonant current Ires, which is a combination of currents in the second and third current loops, flows through the switch Q3. As shown in FIG. 4A, twice the resonant current Ires flows through the first winding L22 (i.e., winding 1) and the second winding L21 (i.e., winding 2) as currents Is1 and Is2, respectively. FIG. 4B shows that the output voltage is one quarter of the input voltage (i.e., Vout=Vin/4). The RMS current Iq1 through the first switch Q1 is about 22.26 A, the RMS current Iq2 through the second switch Q2 is about 21.78 A, and the RMC current Iq3 through the third switch Q3 is about 66.57 A. The RMS current Is1 through the first winding L22 (winding 1) is about 62.29 A, and the mean current Is1 through the first winding L22 (winding 1) is about 55.65 A. The RMS current Is2 through the second winding L21 (winding 2) is about 62.16 A, and the mean current Is1 through the first winding L22 (winding 1) is about 55.50 A. The RMS voltage of the output voltage is about 13.15 V, and the peak-to-peak voltage of the output voltage is about 115.74 mV.

Compared to an LLC converter, because the winding current of the transformer is subjected to full-wave rectification in the HSC converter of FIG. 2, current utilization of the single winding is improved, and winding loss, including, for example, loss caused by the winding being included in a printed circuit board (PCB), can be reduced. Because the effective current flowing in the output-side switches (i.e., switches Q3, Q6 in FIG. 2) can be reduced compared with the current flowing in the similar output-side switches of an LLC converter, losses generated in the output-side switches can also be reduced.

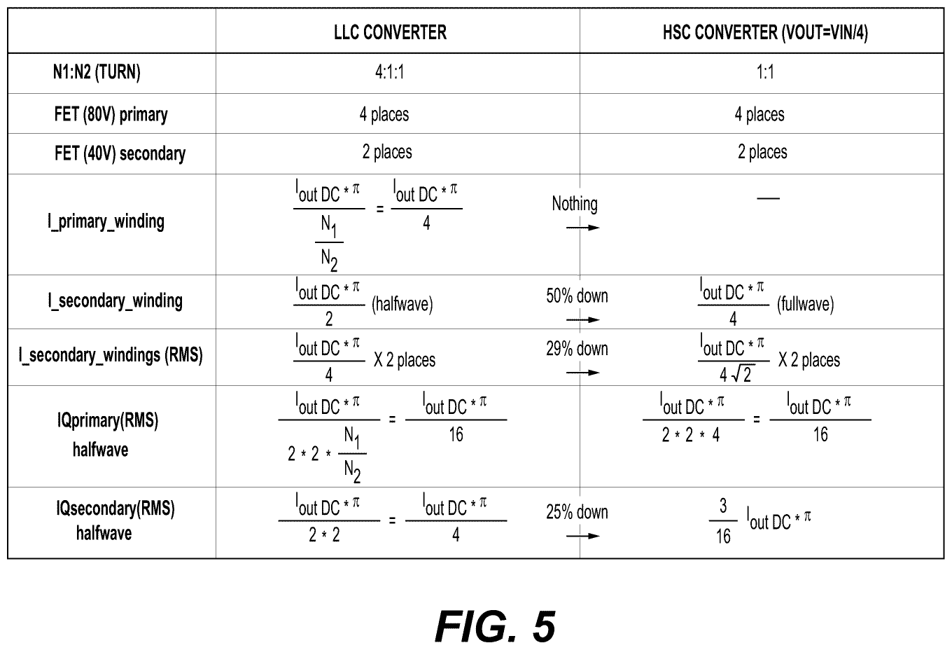

FIG. 5 shows a table comparing a comparable LLC converter to an HSC converter of FIG. 2, where both the LLC converter and the HSC converter provide an output voltage that is one quarter of the input voltage. As shown in the table, the LLC converter has a turns ratio of 4:1:1, while the HSC converter has a turns ratio of 1:1. Both the LLC converter and the HSC converter include four 80-V transistors in the primary circuit and two 40-V transistors in the secondary circuit. The current in the primary winding of the LLC converter is provided by the following equation:

$$\frac{{I}_{out DC} * π}{4} \qquad ( 9 )$$

The HSC converter does not have a primary winding. The halfwave current in the secondary windings of the LLC converter is provided by the following equation:

$$\frac{{I}_{out DC} * π}{2} \qquad ( 10 )$$

And the fullwave current in the secondary windings of the HSC converter is one half of the current of the LLC converter and is provided by the following equation:

$$\frac{{I}_{out DC} * π}{4} \qquad ( 11 )$$

The RMS current in the first and the second secondary windings of the LLC converter is provided by the following equation:

$$\frac{{I}_{out DC} * π}{4} \qquad ( 12 )$$

And the RMS current in the first and the second secondary windings of the HSC converter is approximately 29% of the current of the LLC converter and is provided by the following equation:

$$\frac{{I}_{out DC} * π}{4 \sqrt{2}} \qquad ( 13 )$$

The RMS currents in the primary switches in the LLC converter and in the HSC converter are halfwave and are provided by the following equation:

$$\frac{{I}_{out DC} * π}{16} \qquad ( 14 )$$

The RMS current in the secondary switch of the LLC converter is halfwave rectified and is provided by the following equation:

$$\frac{{I}_{out DC} * π}{4} \qquad ( 15 )$$

And the RMS current in the secondary switch of the HSC converter is halfwave rectified and is three quarters of the current of the LLC converter and is provided by the following equation:

$$\frac{3 * {I}_{out DC} * π}{16} \qquad ( 16 )$$

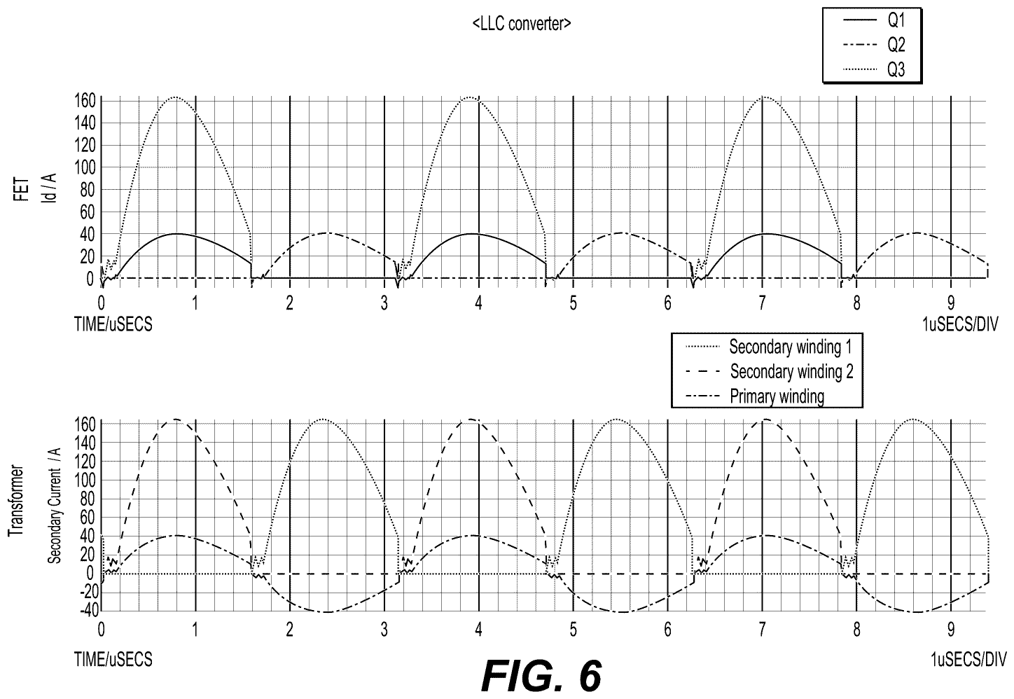

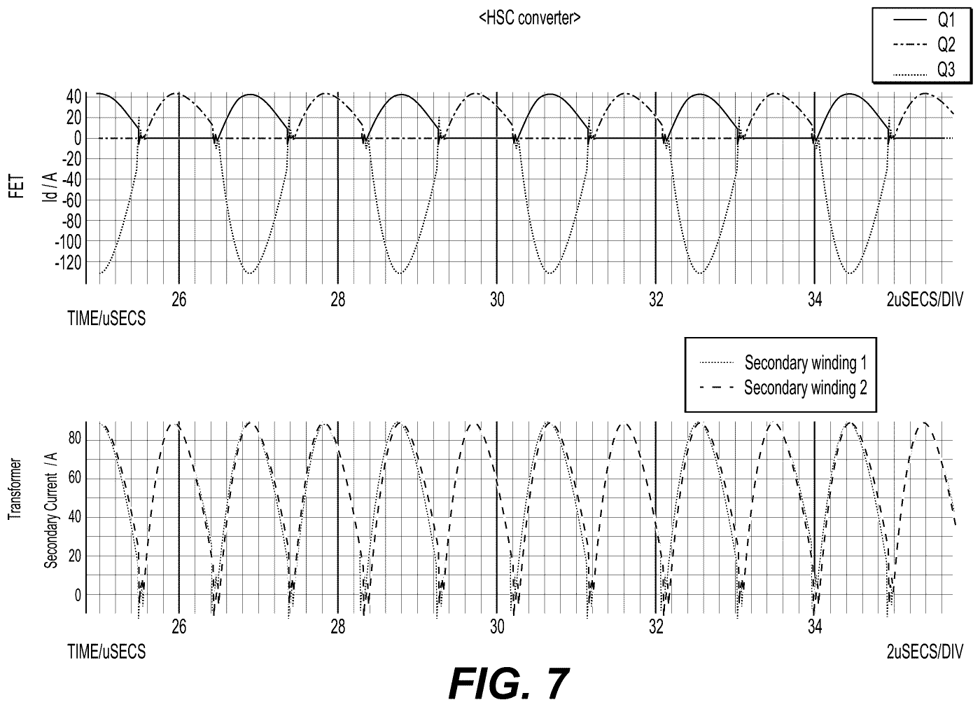

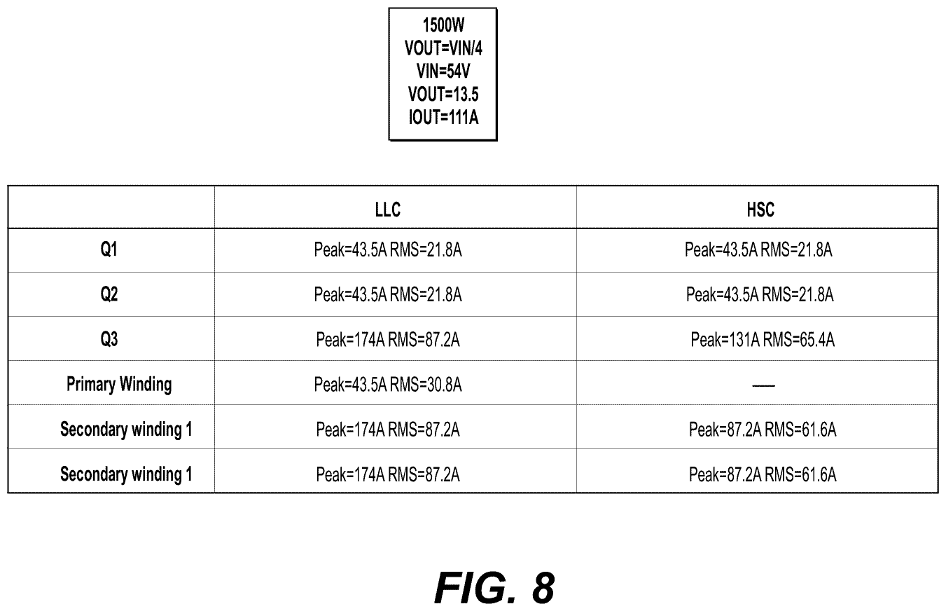

FIGS. 6 and 7 shows graphs of current waveforms of comparable LLC and HSC converters that provide an output voltage is one quarter of the input voltage. Both the LLC converter and the HSC converter are capable of providing 1500 W of power. The input voltage is 54 V, the output voltage is 13.5 V, and the output current is 111 A. For the LLC converter, FIG. 6 shows graphs of the current waveforms for switches Q1-Q3 in the upper portion and for the primary winding and the first and second secondary windings in the lower portion. For the HSC converter, FIG. 7 shows graphs of the current waveforms for switches Q1-Q3 in the upper portion and for the first and second secondary windings in the lower portion. The table in FIG. 8 summarizes the peak and RMS current of the graphs in FIGS. 6 and 7. In the LLC converter, through the first switch Q1, the peak current is 43.5 A, and the RMS current is 21.8 A; through the second switch Q2, the peak current is 43.5 A, and the RMS current is 21.8 A; and through the third switch Q3, the peak current is 174 A, and the RMS current is 87.2 A. Through the primary winding, the peak current is 43.5 A, and the RMS current is 30.8 A; through the first secondary winding, the peak current is 174 A, and the RMS current is 87.2 A; and through the second secondary wind, the peak current is 174 A, and the RMS current is 87.2 A. In the HSC converter, through the first switch Q1, the peak current is 43.5 A, and the RMS current is 21.8 A; through the second switch Q2, the peak current is 43.5 A, and the RMS current is 21.8 A; and through the third switch Q3, the peak current is 131 A, and the RMS current is 65.4 A. There is no primary winding in the HSC converter. Through the first secondary winding, the peak current is 87.2 A, and the RMS current is 61.6 A; and through the second secondary wind the peak current is 87.2 A, and the RMS current is 61.6 A.

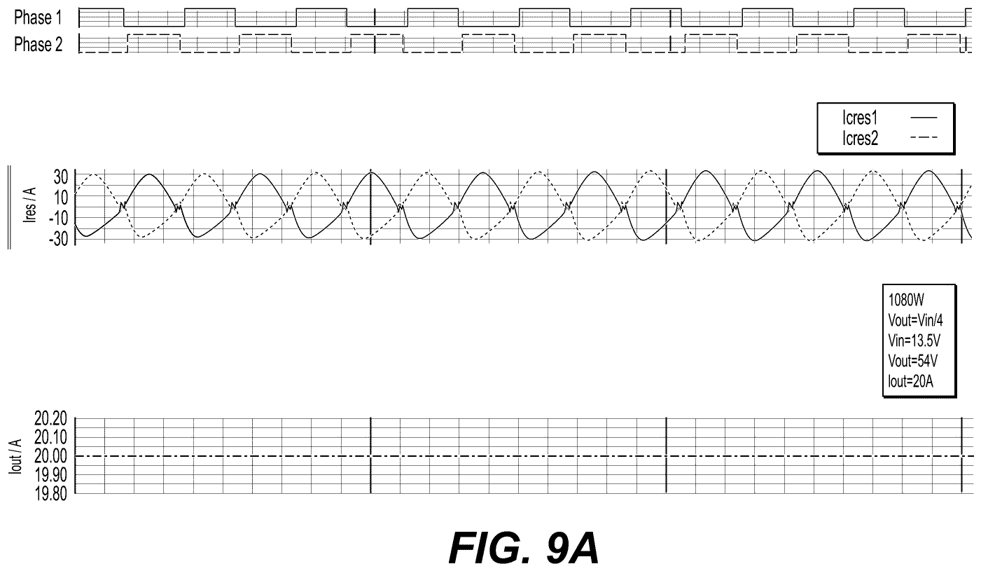

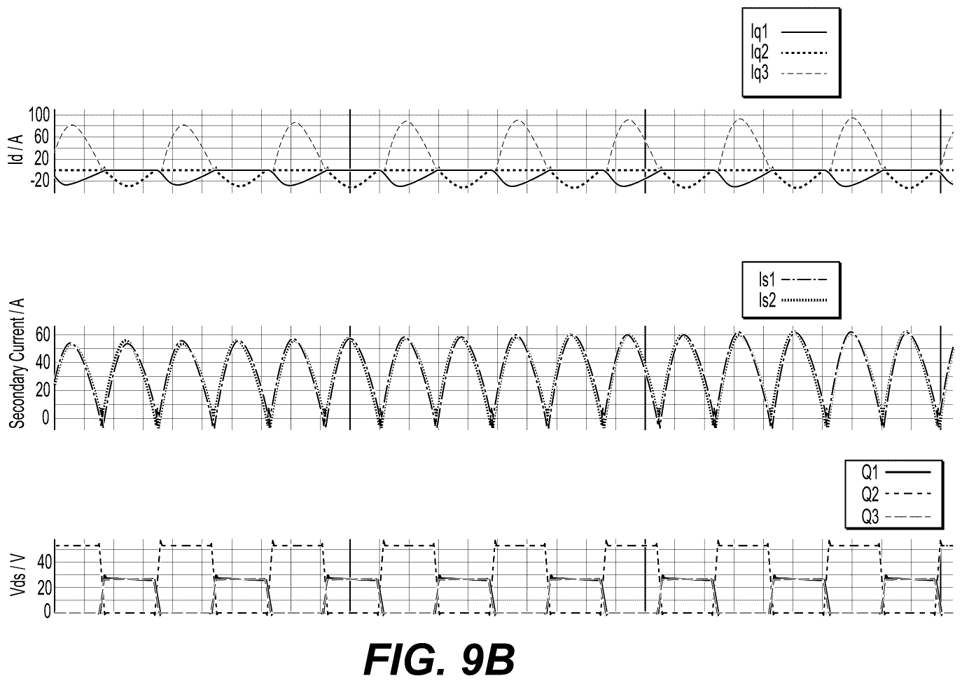

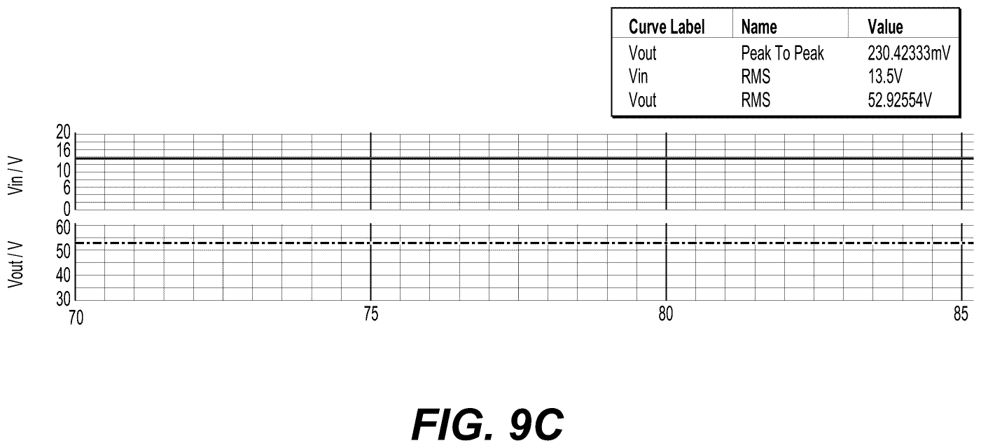

FIGS. 9A-9C show waveforms of a simulation of bidirectional behavior of the HSC converter of FIG. 2 if power flows from the output terminal Vout to the input voltage Vin. FIGS. 9A-9C show waveforms for a simulation of a 1080-W HSC converter that includes a 13.5-V input at the output terminal Vout, a 54-V output (=Vin*4=13.5 V*4) at the input voltage Vin, and 20 A output current. Similar to the normal operation shown in FIG. 4 as discussed above, FIGS. 9A-9C confirm that power can flow in the opposite direction, with switches being driven by two PWM signals so that resonance currents Ires in the first and the second resonant circuit flows. FIG. 9C confirms that the output voltage (i.e., the voltage at the input voltage Vin) is four times the input voltage (i.e., the voltage at the output terminal Vout) (Vin=4×Vout). The peak-to-peak output voltage is approximately 230.42 mV. The RMS input voltage is 13.5 V, and the RMS output voltage is approximately 52.93 V.

From the simulation results discussed above, it has been confirmed that the output voltage that is one quarter of the input voltage can be supplied with the primary winding removed, the effective current flowing in the secondary winding is reduced by 29% compared with a comparable LLC converter system, that the effective current flowing through the secondary switches is reduced by 25% compared with the LLC converter system, and that the HSC converter of FIG. 1 can be operated as bidirectionally and can be used as a bidirectional power supply.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An HSC voltage conversion module comprising:
an input voltage;
a transformer without a primary winding and including secondary windings magnetically coupled by a magnetic core;
first and second switch bridges connected to the transformer and to the input voltage; and
an output capacitor that is connected to a single node of the transformer and that provides an output voltage that is one quarter of the input voltage.

2. The HSC voltage conversion module of claim 1, further comprising:
a first resonant circuit connected between the first switch bridge and the transformer; and
a second resonant circuit connected between the second switch bridge and the transformer.

3. The HSC voltage conversion module of claim 2, wherein
the first resonant circuit includes a first resonant capacitor;
the second resonant circuit includes a second resonant capacitor; and
the first and the second resonant circuits rely on a leakage inductance of the transformer.

4. The HSC voltage conversion module of claim 1, wherein each of the first and second switch bridges includes first, second, and third switches connected in series.

5. The HSC voltage conversion module of claim 1, wherein the secondary windings of the transformer include first and second windings.

6. The HSC voltage conversion module of claim 1, wherein the HSC voltage conversion module is bidirectional.

7. A converter comprising:
an input terminal that receives an input voltage;
a first switch bridge connected in parallel across the input voltage and including:
first, second, and third switches connected in series;
a first node between the first and the second switches; and
a third node between the second and third switches;
a second switch bridge including:
fourth, fifth, and sixth switches connected in series;
a second node between the fourth and the fifth switches; and
a fourth node between the fifth and sixth switches;
an output capacitor;
a transformer including:
a single winding that includes first and second secondary windings that are physically connected to each other to define a secondary winding group and that are magnetically coupled by a magnetic core; and
a single tap connected to the output capacitor;
a first resonant circuit connected between the first node and a first end of the single winding;
a second resonant circuit connected between the second node and a second end of the single winding opposite to the first end of the single winding; and
an output terminal connected to the first output capacitor to provide a first output voltage that is one quarter of the input voltage.

8. The converter of claim 7, wherein
the first resonant circuit includes a first resonant capacitor;
the second resonant circuit includes a second resonant capacitor; and
the first and the second resonant circuits rely on a leakage inductance of the transformer.

9. The converter of claim 7, wherein the converter is bidirectional such that power can flow from the input terminal to the output terminal and from the output terminal to the input terminal.
